(19) United States
(12) Patent Application Publication
(10) Pub. No.: US 2026/0270576 A1
(43) Pub. Date: Sep. 10, 2026

(54) IMAGE SENSOR PIXEL, IMAGE SENSOR, AND METHOD FOR OPERATING AN IMAGE SENSOR PIXEL

(71) Applicant: Sony Semiconductor Solutions Corporation, Kanagawa (JP)

(72) Inventors: Daniel VAN NIEUWENHOVE, Basingstoke (GB); Maarten KUIJK, Basingstoke (GB)

(73) Assignee: Sony Semiconductor Solutions Corporation, Kanagawa (JP)

(21) Appl. No.: 19/167,840

(22) PCT Filed: Mar. 28, 2024
(86) PCT No.: PCT/EP2024/058452

§ 371 Date: Sep. 23, 2025

(30) Foreign Application Priority Data
Mar. 31, 2023 (EP) 23165795.8

(51) Int. Cl. H04N 25/47; H04N 25/773

(52) U.S. Cl. CPC H04N 25/47; H04N 25/773

(57) ABSTRACT

The present disclosure generally pertains to image sensor pixel circuitry comprising: a single photon avalanche diode configured to generate a pulse in response to detection of incident photons; a charge pump configured to integrate a number of the incident photons; a comparator configured to generate an overflow signal when the number of incident photons exceeds a predetermined threshold; and a sample and hold switch configured to register a point of time at which the overflow signal is generated.

### TECHNICAL FIELD

The present disclosure generally pertains to an image sensor pixel, an image sensor, and a method for operating an image sensor pixel.

### TECHNICAL BACKGROUND

Single photon avalanche diodes/detectors (SPADs) are generally known. For example, shot-noise limited operation may be possible with a SPAD, which may allow for low light level image acquisition.

To provide for low-light level as well as high-light level acquisitions, i.e., high dynamic range (HDR) operation, it is known to use a digital counter. Also, it may be known to generate an overflow signal for turning off the SPAD when a threshold is reached by photon counting, thereby avoiding unnecessary successive heat-generating SPAD triggering.

For example, in J. Ogi, et al., “A 124-dB Dynamic Range SPAD Photon-Counting Image Sensor Using Subframe Sampling and Extrapolating Photon Count,” in IEEE Journal of Solid-State Circuits, vol. 56, no. 11, pp. 3220-3227, Nov. 2021, doi: 10.1109/JSSC.2021.3114620, a method is described in which an overflow signal is used that records a time-count signal, and shuts-off the SPAD after a number of triggers.

SPAD technology may be used for a time-of-flight measurement, such as direct time-of-flight (dToF) in which a roundtrip delay of emitted light may be determined in order to determine/calculate a distance to a scene, and to acquire a three-dimensional image of the scene.

Although there exist techniques for operating a SPAD, it is generally desirable to provide an image sensor pixel, an image sensor, and a method for operating an image sensor pixel.

### SUMMARY

According to a first aspect, the disclosure provides an image sensor pixel comprising:
a single photon avalanche diode configured to generate a pulse in response to detection of incident photons;
a charge pump configured to integrate a number of the incident photons;
a comparator configured to generate an overflow signal when the number of incident photons exceeds a predetermined threshold; and
a sample and hold switch configured to register a point of time at which the overflow signal is generated.

According to a second aspect, the disclosure provides an image sensor comprising a plurality of image sensor pixels, each pixel including:
a single photon avalanche diode configured to generate a pulse in response to detection of incident photons;
a charge pump configured to integrate a number of the incident photons;
a comparator configured to generate an overflow signal when the number of incident photons exceeds a predetermined threshold; and
a sample and hold switch configured to register a point of time at which the overflow signal is generated, wherein
the image sensor further comprises image sensor circuitry configured to only output a read-out signal for the pixels of the plurality of image sensor pixels which generated an overflow signal.

According to a third aspect, the disclosure provides a method for operating an image sensor pixel, the method comprising:
generating, by a single photon avalanche diode, a pulse in response to detection of incident photons;
integrating, by a charge pump, a number of the incident photons;
generating, by a comparator, an overflow signal when the number of incident photons exceeds a predetermined threshold; and
registering, by a sample and hold switch, a point of time at which the overflow signal is generated.

Further aspects are set forth in the dependent claims, the drawings, and the following description.

### BRIEF DESCRIPTION OF THE DRAWINGS

Embodiments are explained by way of example with respect to the accompanying drawings, in which:

FIG. 1 shows an embodiment of an image sensor pixel based on a SPAD circuit, a charge pump circuit, a comparator, and a sample and hold circuit;

FIG. 2 shows transient signals of an operation of the circuit of FIG. 1, demonstrating low light level incidence, not triggering an overflow;

FIG. 3 shows transient signals of an operation of the circuit of FIG. 1, demonstrating high light level incidence, triggering an overflow;

FIG. 4 shows transient signals of an operation of the circuit of FIG. 1, demonstrating low light level incidence, not triggering an overflow, similar to FIG. 2, but with a logarithmic time-scale relative to the start of the frame, for a 2-ms frame;

FIG. 5 shows transient signals of an operation of the circuit of FIG. 1, demonstrating high light level incidence, triggering an overflow, similar to FIG. 3, but with a logarithmic time-scale relative to the start of the frame, for a 2-ms frame;

FIG. 6 shows an embodiment of an image sensor pixel, further including circuitry for averaging out the low and high light levels and respectively, over multiple frames improving the Signal-to-Noise Ratio (SNR);

FIG. 7 shows an embodiment of an image sensor pixel, having additional circuitry for comparing a single frame with the previous recorded and averaged light levels, flagging sudden substantial change in light-levels;

FIG. 8 shows a circuit according to the prior art in which 3D-time-of-flight acquisition can be achieved and or integrated in the pixel;

FIG. 9 shows a way to construct a non-linear voltage curve that drops as indicated in FIG. 5; and

FIG. 10 depicts a block diagram of a method for operating an image sensor pixel according to the present disclosure.

### DETAILED DESCRIPTION OF EMBODIMENTS

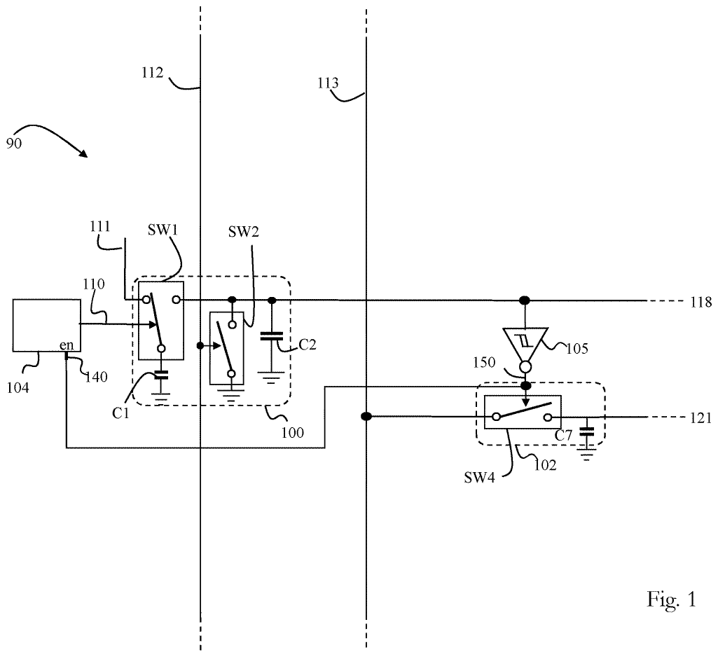

Before a detailed description of the embodiments starting with FIG. 1 is given, general explanations are made.

As mentioned in the outset, SPAD circuits are already known. However, it has been recognized that if a digital counter is used to provide high dynamic range (HDR) operation, the SPAD may underlie high triggering rates which may cause high power and heat dissipation. Moreover, using a digital counter may require hundreds of transistors per pixel, limiting how small a pixel can be made.

It has been recognized that it may be desirable to provide a small circuit which may be integrated on a per pixel base.

Such a circuit may, for example, rely on an analog (or digital) charge pump, sample-and-hold, on switched capacitor averaging, and the like, thereby providing HDR image acquisition.

In some embodiments, it may also become possible to sense, during low power mode operation, sudden light input changes on which other actions may be instigated. This may enable event driven operation of various kinds.

In some embodiments, it may become possible, for example in conjunction with an external pulsed light-source for illuminating a scene, to obtain time-of-flight operation, all within one pixel. For a full sensor, this may allow for 3D camera, high dynamic range RGB, and low-power operation all in one pixel circuit.

Averaging time-count signals inside pixels may require an order of magnitude more transistors, thus enlarging pixel areas. On the other hand, such data can also be communicated outside the array, which, as has been recognized, leads to a lot of digital data communication, which may be challenging to achieve.

Therefore, some embodiments pertain to an image sensor pixel including: a single photon avalanche diode configured to generate a pulse in response to detection of incident photons; a charge pump configured to integrate a number of the incident photons; a comparator configured to generate an overflow signal when the number of incident photons exceeds a predetermined threshold; and a sample and hold switch configured to register a point of time at which the overflow signal is generated.

For example, the image sensor pixel circuitry may include at least one of the following without limiting the present disclosure in that regard: SPAD circuitry for generating the pulse; a charge pump for integrating the number of incident photons; a comparator for generating the overflow signal; a sample and hold switch for registering the point of time.

It should be noted that at least some of the above-mentioned units and/or their functions may at least partially be carried out by an integrated unit, such as a processor.

In some embodiments, the registering is based on a monotonic signal (e.g., curve 214, as will be discussed below).

In some embodiments, the monotonic signal is a monotonically increasing or monotonically decreasing signal.

In some embodiments, the monotonic signal is provided for high dynamic range light input reconstruction.

In some embodiments, the monotonic signal is an analog signal.

In some embodiments, the sample and hold switch is further configured to sample the monotonic signal for registering the point of time.

In some embodiments, the monotonic signal corresponds to a non-linear curve.

In some embodiments, the charge pump includes a switching capacitor configured to integrate the number of the incident photons, wherein the integrated number of photons is determined based on an average voltage of the switching capacitor.

In some embodiments, the image sensor pixel is further configured to, based on the number of photons, to lock a voltage value which is indicative of a light level.

In some embodiments, the pixel is a time-of-flight pixel.

In some embodiments, the comparator is configured to detect a change in the scene.

Some embodiments pertain to an image sensor including a plurality of image sensor pixels, each pixel including: a single photon avalanche diode configured to generate a pulse in response to detection of incident photons; a charge pump configured to integrate a number of the incident photons; a comparator configured to generate an overflow signal when the number of incident photons exceeds a predetermined threshold; and a sample and hold switch configured to register a point of time at which the overflow signal is generated, wherein the image sensor further includes image sensor circuitry configured to only output a read-out signal for the pixels of the plurality of image sensor pixels which generated an overflow signal.

In some embodiments, the image sensor may be configured to only output a read-out signal for the pixels having generated an overflow signal. An overflow signal may be generated by the comparator of each pixel when a change is detected in the scene. In that way, the image sensor read-out is optimized to output only changed pixels, thereby reducing the image sensor's power consumption.

It should be understood that the explications given herein for the image sensor pixel apply accordingly to the image sensor, and repetitive description is omitted.

Some embodiments pertain to a method for operating an image sensor pixel, the method including: generating, by a single photon avalanche diode, a pulse in response to detection of incident photons; integrating, by a charge pump, a number of the incident photons; generating, by a comparator, an overflow signal when the number of incident photons exceeds a predetermined threshold; and registering, by a sample and hold switch, a point of time at which the overflow signal is generated, as discussed herein.

In some embodiments, the registering is based on a monotonic signal, as discussed herein. In some embodiments, the monotonic signal is a monotonically increasing or monotonically decreasing signal, as discussed herein. In some embodiments, the monotonic signal is provided for high dynamic range light input reconstruction, as discussed herein. In some embodiments, the monotonic signal is an analog signal, as discussed herein. In some embodiments, the method further includes, by the sample and hold switch, sampling the monotonic signal for registering the point of time, as discussed herein. In some embodiments, the monotonic signal corresponds to a non-linear curve, as discussed herein. In some embodiments, the charge pump includes a switching capacitor, the method further comprising: integrating, by the switching capacitor, the number of incident photons, wherein the integrated number of photons is determined based on an average voltage of the switching capacitor, as discussed herein. In some embodiments, the method further includes, based on the number of photons, locking a voltage value which is indicative of a light level, as discussed herein. In some embodiments, the pixel is a time-of-flight pixel, as discussed herein, as discussed herein. In some embodiments, the method further includes, by the comparator, detecting a change in the scene.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

According to the present disclosure, high dynamic range light level acquisitions based on SPADs can be achieved, starting from very low light levels up to possibly very high light levels in a way that the SPADs only need to trigger on a limited number of incident photons, thereby avoiding unnecessary heating of the circuitry.

Therefore, way is provided to achieve this, based on a charge pump, a comparator, and registering a moment of overflow of a predetermined number of photons by sampling the analog signal at the moment of overflow. The sampled analog value gives a clear indication of the moment of overflow, and hence allows to derive the incident light level.

This process can be repeated several times, such as 10 to 100 times, without limiting the present disclosure in that regard, wherein each sampled analog signal may take part in an averaging process by a switch capacitor circuit, thereby increasing a signal to noise ratio.

A variation of the analog signal versus time may be chosen in a way that a good signal-to-noise ratio is available over the full incident light range, without limiting the present disclosure in that regard.

Therefore, according to the present disclosure, voltage change (versus time) is the one that shows a linear line on a (fictitious) graph that is drawn on a logarithmic time-scale over several orders of time-magnitude, hence over several orders of incident light. A linear rate of change of the voltage versus time (on a linear time scale), or even an exponential voltage decay versus time (on a linear time scale), may also be possible, but in such embodiments, the dynamic range of the recording may be jeopardized.

Returning to FIG. 1, there is shown an embodiment of an image sensor pixel 90 according to the present disclosure. A SPAD circuit 104 includes a light sensitive SPAD, that outputs a trigger signal SPADtrigger 110, each time at least one photon is sensed. The SPAD circuit 104 may be of any type, including passive quenching, active quenching, with and without one or more enabling inputs, it may include circuits to regulate the SPAD's excess bias voltage, and the like. Input en 140 is used to enable or disable possible “firing” (triggering) of the SPAD. By making en 140 LOW, the SPAD is disabled, and the power dissipation under high light level conditions can be reduced significantly.

The pixel further includes a charge pump 100 including an analog circuit. The charge pump 100 may be of any charge pump type. In this embodiment, the charge pump includes two switches and two capacitors.

A first capacitor C1, is connected to biasV 111 by a first switch SW1, which will under instigation of a pulse on node SPADtrigger 110
disconnect from node bias V 111,
then connect to node LowLL 118,
then disconnect from node LowLL 118,
and then re-connect again to biasV 111.

Attached to LowLL 118 is a second capacitor C2 that is configured to hold a voltage representing an integrated photon count since a reset point in time. At a start of a frame, the voltage can be reset by pulsing the voltage on node frameStart 112 high.

How to achieve this toggling of connections with two non-overlapping clocks and two NMOS switches is described in patent WO2022043480. At the start of a frame, SW2 is first pulsed high by node frameStart 112, in that way, discharging C2 to ground, ready for starting an analog counting from zero volts. By choosing C2 much larger than C1, it is achieved that each time a SPADtrigger 110 pulses, the voltage on C2, being the signal on node LowLL 118, will increase by a few millivolts, as determined by C1, C2 and biasV 111 combination. Example value for C1 is 10-100 attofarads, and for C2 a value that is 100 to 1000 times larger, depending on how fast the system needs to reach the overflow voltage level Vtrip 212. With a C2 that is 400 times larger than C1, it may be possible to reach, after circa two-hundred SPAD-triggers, Vtrip 212, if Vtrip 212 is biased at fifty percent of the voltage on node biasV 111. However, the numbers and magnitudes given herein should only be understood as illustrational and not as limiting.

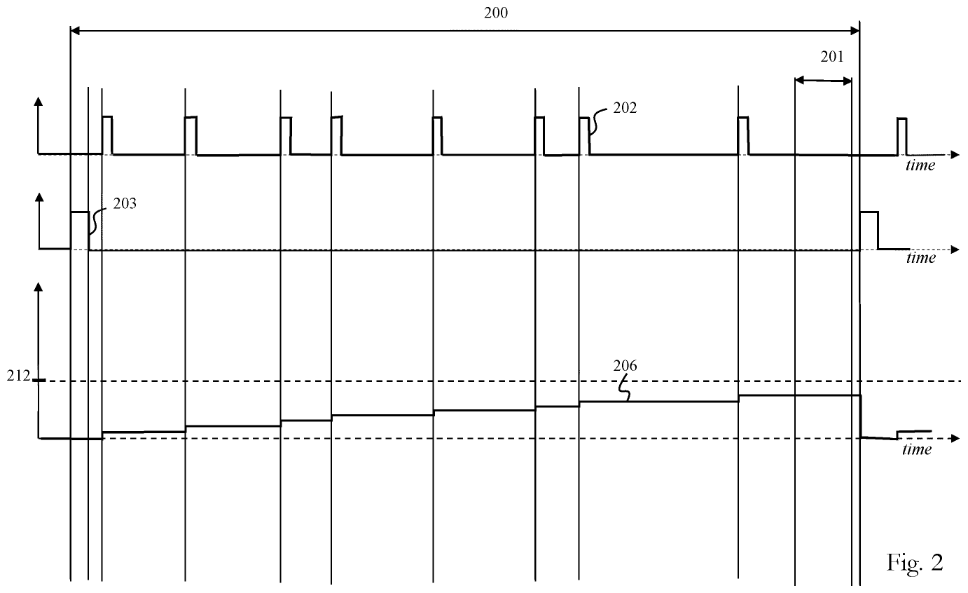

The charge pump operation is illustrated in FIG. 2, where switch SW2 gets pulsed by frameStart 112 (curve frameStart 203), resetting the voltage on node LowLL 118 to zero volts (curve LowLL 206). Each time there is pulse on node SPADtrigger 110, signal LowLL 206 increases a little, as described above. In this figure, low light level conditions are assumed with as a result, that by the end of the frame 200, the voltage LowLL 206 is still below a tripping point Vtrip 212.

In a period at the end of the frame, the voltage on node LowLL 118 can be read out. This can be done by a voltage follower transistor and through a row-select switch, or the like.

A comparator 105 compares the voltage on the node LowLL 118 with the Vtrip 212.

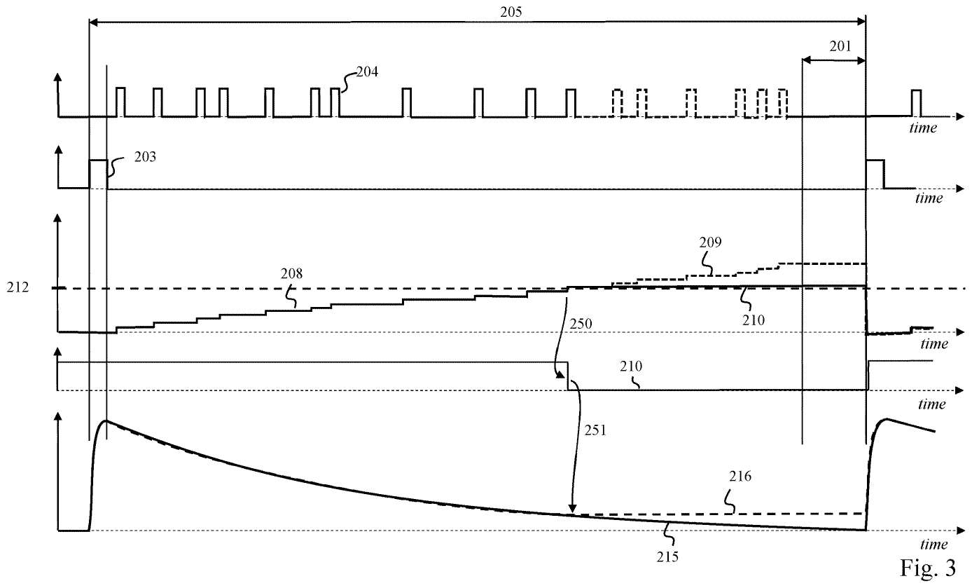

In this embodiment, the comparator 105 is embodied as a Schmitt trigger having an inherent upper tripping voltage when applying a voltage that is rising in time. Node NotOverFlow 150 signals by a falling edge when Vtrip gets surpassed in voltage. This happens under high light level conditions, in FIG. 3.

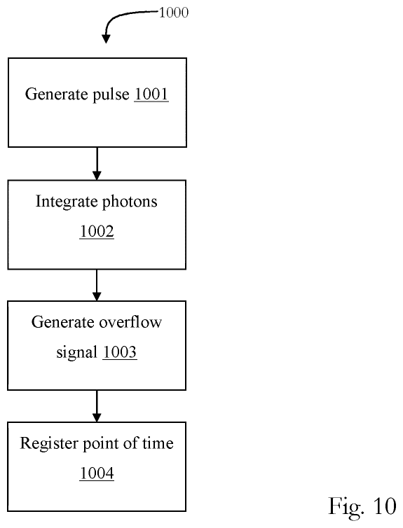

A time-to-analog signal is applied on node ttA 113. This is a voltage that changes monotonically and is intended to timestamp the moment in time when an overflow occurs; in the example of FIG. 3, it decreases e.g., starting from 1V, and gradually decreases further down to 0V when approaching the end of the frame. This signal is applied repeatedly in the same way to each frame. This voltage can be generated in a specific circuit 604 (as described under reference of FIG. 9), and this voltage may be applied to an array of pixels simultaneously and the circuitry for generating the signal can be common circuitry to an image sensor array.

Node HighLL 121 is connected to node ttA 113 through switch SW4 as long as the voltage on node NotOverFlow 150 is HIGH. The voltage on node HighLL 121 will then follow the voltage on node ttA 215.

At the time that NotOverflow 150 switches to LOW, the voltage on node HighLL 121 will however stay at its last level because of a holding-capacitor C7. This is exemplified by curves HighLL 216 and ttA 215 in FIG. 3. In this embodiment, the rate of SPADtrigger pulses 204 is much higher than in FIG. 2, and LowLL 208 surpasses Vtrip 212 at position 250.

NotOverFlow 210 goes to LOW, and as a result, the voltage on node HighLL 121, curve HighLL 216, remains fixed, no longer following curve ttA 215. If the SPAD circuit is set-up to be disabled when NotOverFlow 150 goes LOW, LowLL 208 will stop increasing from point 250 onwards, following curve 210. When the SPAD circuit is set-up to not disable, LowLL 208 will keep increasing from 25 onwards, following curve 209 and surpassing the Vtrip 212 voltage until the analog counter saturates, or until frame period 205 is over. Circuit 102 thus serves as a sample-and-hold circuit.

The analog signal that is provided and called ttA 113 is intended to provide a means to record, in an analog way, the moment in time (point of time) at which an overflow occurs. Subsequent sampled moments can be averaged out over subsequent overflow occurrences, as to achieve a more precise moment, and thus more precise incident light input estimate.

It is to be noted, that instead of an analog tta voltage, also a time-to-digital (ttd), e.g., an external digital counter or gray code generator (counting linear or logarithmic), could be used. In such an implementation, at position 250, surpassing Vtrip 212, a set of digital memories may record the current digital value of such ttd signal. However, digital averaging may be more complex and tough to implement on a per pixel basis, while the tta approach described above may allow for further averaging.

In a read period 201, one or both of the analog signals present on nodes LowLL 118 and HighLL 121 can be passed on to read-out circuitry including Analog-to-Digital converters.

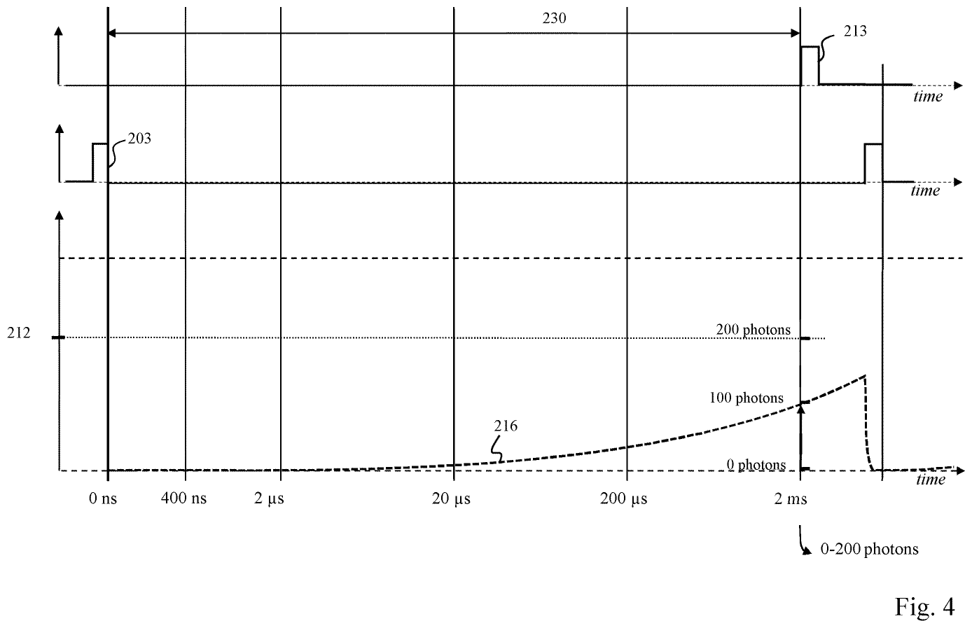

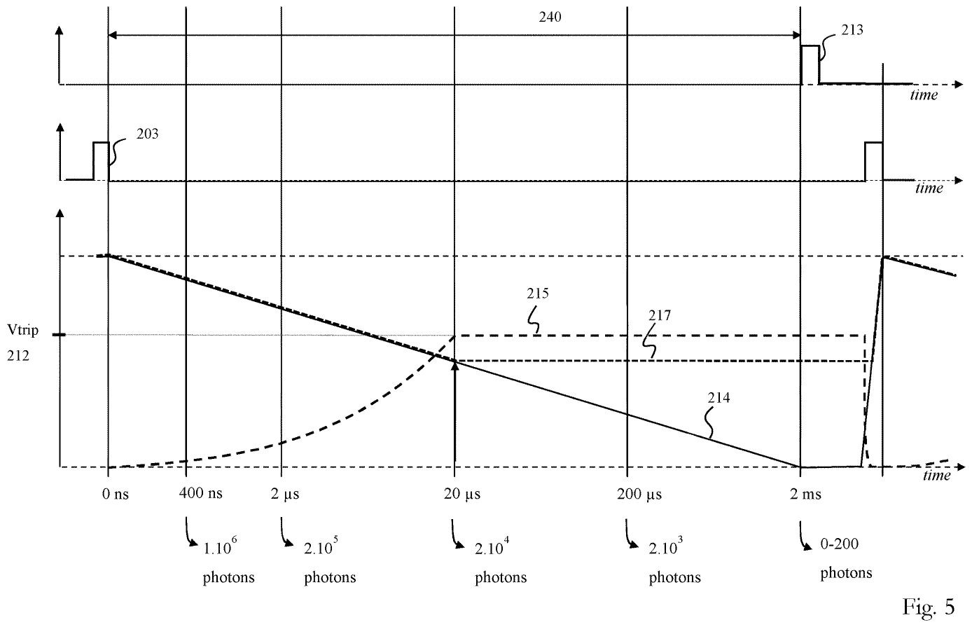

FIGS. 4 and 5 show an implementation example for the circuitry as discussed under reference of FIGS. 1 to 3.

FIG. 4 demonstrates the low light level operation, as discussed under reference with FIG. 2. C1, C2, bias V 111 and Vtrip 212 are, in this embodiment, designed to have a maximum count of 200 and then trip.

LowLL 216 curve shows a case where at low light level, i.e., 100 photons, are reached in a frame period 230 of two milliseconds. The Y-axes are linear in voltage, whilst the X-axes are on a logarithmic scale. Even though LowLL 216 is statistically linearly rising in case of a fixed light level condition, due to the logarithmic scale it seems no longer linear.

As can be taken from FIG. 4, the number of photons rises, but the generated voltage does not reach Vtrip. The number of photons decreases at the end of the frame due to a reset.

FIG. 5 shows a higher light level condition, i.e., of 20000 photons in a same length period 240 of two milliseconds. In this embodiment, the curve LowLL 215 increases hundred times faster compared to when 200 photons would be incident in the frame. Instead of two milliseconds, it only takes 20 μs to reach Vtrip 212. At the 20 μs moment, Vtrip 212 is reached by LowLL 215, and the voltage on curve HighLL 217 gets fixed because SW4 stops to conduct.

At the end of the frame, this fixed voltage is read out on node HighLL 121, revealing the sampling moment, and thus the measured light level by use of only 200 photons from the start of the period 240.

If the SPAD circuit is configured to disable in response to a signal, NotOverFlow 150 becoming LOW, the number of SPAD triggers will be limited to 200 under this high light level condition. Similarly, if the light level is very high, e.g., a million photons per two milliseconds, the max count of 200 photons may be reached already after 400 ns.

By distributing the ttA 214 voltage in accordance with FIG. 5, starting at 1V, and ending at 0V for the full fame period 240, High Dynamic Range operation is supported. Assuming an accuracy of the ADC in the read-out circuit is 1 mV for 1 V (~10 bit), it may be achieved that over the full indicated high light level range of 200-1000000 photons, the 1-mV discretization may correspond to a variation of only 1% of incident light level variation.

A single frame will still have quite some shot-noise since each measurement is based on 200 photons only. The SNR is then 200/\sqrt{200}=14.1 which gives a sigma of ~7% on the measured light level. If an application needs a better SNR, the maximum count may be increased, or it is possible to average out multiple frames by adding additional circuitry. The subsequent low light level voltages on node LowLL 118 can be averaged, as well as the high light level values that get to node HighLL 121.

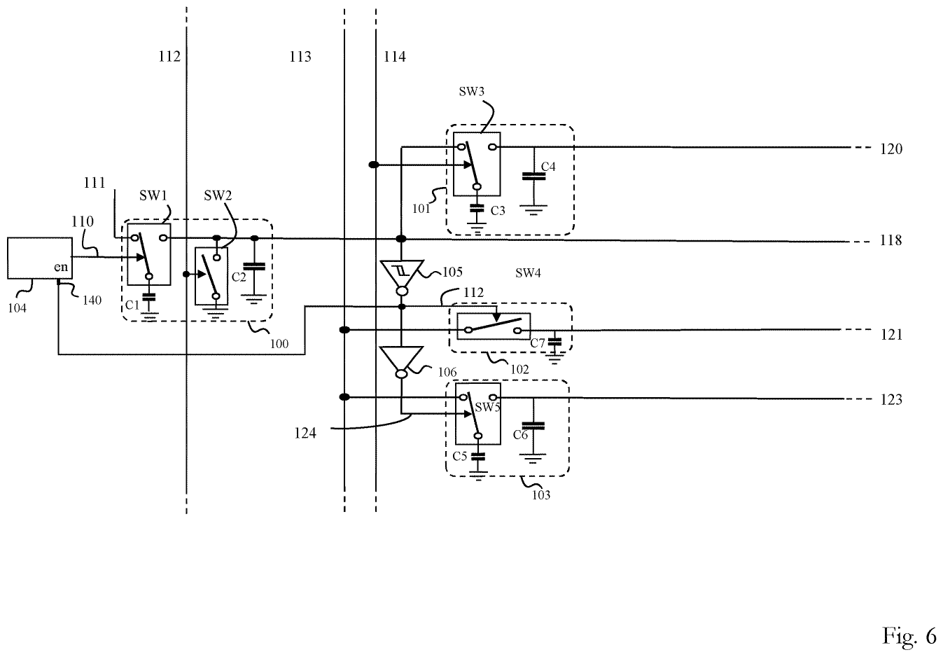

For this purpose, in FIG. 6, exponential moving averaging (EMA) circuits are included compared to the circuitry of FIG. 1, namely circuit 101 for generating the signal on node AverageLowLL 120, and circuit 103 for generating the signal AverageHighLL 123.

When capacitors C4 and C6 are roughly ten times larger than C3 and C5, this circuitry will include the last measured values for about 10% in the new averaging results, and the other 90% is a remainder of the 10-20 previous samples (with less weight for older signals). Patent WO2022043480 explains this in more detail. Assume that we have an averaging length of 10, and assuming that the incident light level isn't changing during the 10 frames, the SNR improves to 2000/\sqrt{2000}=44.7 which gives a sigma of ~2.2% on the measured light level.

For many applications this may already be good enough. However, it can be further improved by increasing a maximum count level or the number of frames per macro frame. For example, ten frames of two milliseconds each give a twenty milliseconds macro frame at 50 fps (frames per second). At low light level conditions, the SNR may improve similarly.

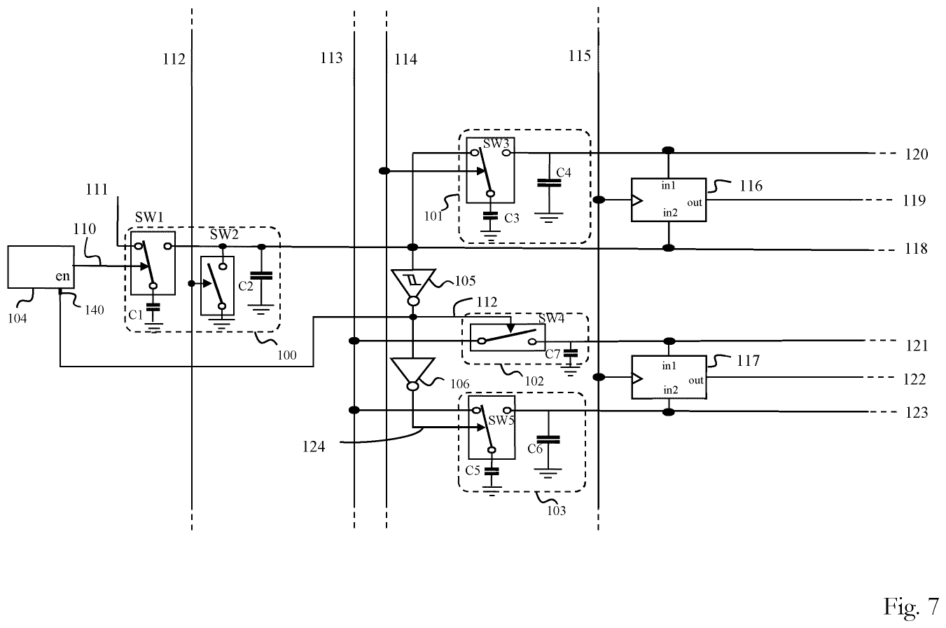

Having in each pixel the result of the last frame (on node LowLL 118 and HighLL 121), and that of the average over the last frames (AverageLowLL 120 and Average HighLL 123), additional circuitry can be included such as comparator 116 and comparator 117, as depicted in FIG. 7.

Based on these comparators, it may be possible to tell whether there is a large deviation present on the latest frame compared to the stored average. The comparators 116 and 117 have internal circuitry that can output a digital signal that flags that a new incoming value is much different than the stored average.

Using a logarithmic scale for the signal ttA 114 as proposed in FIG. 5, may result in a situation that a 1-mV change on HighLL 121 corresponds to a ~1% change in light intensity. For targeting a flagging threshold of 20%, a difference (positive or negative) of 20 mV may be sensed by comparator 117. Exact implementation details can be adapted and configured by the person skilled in the art.

In some embodiments, such difference measurement could be carried out multiple (consecutive) times. In such embodiments, a first averaging may take place targeting output frame rates of 1000 fps, for example.

A second averaging may be applied with, for example, 100 fps, and a third averaging may be applied with, for example, 10fps.

In such a configuration, change can be detected between instantaneous and 1000 fps allowing very low latency flagging of changes in the scene, while at the same time having circuitry that gives a current 10 fps average value for the light intensity.

With such a configuration, firstly, stable data may be obtained, and then only every hundred milliseconds, it may be checked, if there is a change, requiring only one (or a few) determination cycles (determining lowLL).

Thereby, power may be saved and, as soon as change is detected, a determination rate for determining the overflow (or lowLL) may be increased.

It is to be noted, that in case the circuit initially does not have lowLL overflow, and then changes to lowLL overflow, this may be considered a change flag. The circuitry may be designed in such a way that lowLL can still count a beyond overflow, in case the image intensity is around the overflow level (200 events in above example). In such case switching between lowLL output and highLL output may create difficulties, which may then be handled by enabling lowLL to count higher (e.g., 250 events), or highLL to trigger earlier (e.g., 150 events).

In some embodiments, lowLL is not averaged and not outputted, and only highLL approaches are used, or vice versa, also a double lowLL circuit may be provided, in which a first lowLL at overflow triggers one up-count of a second lowLL circuit, or the like.

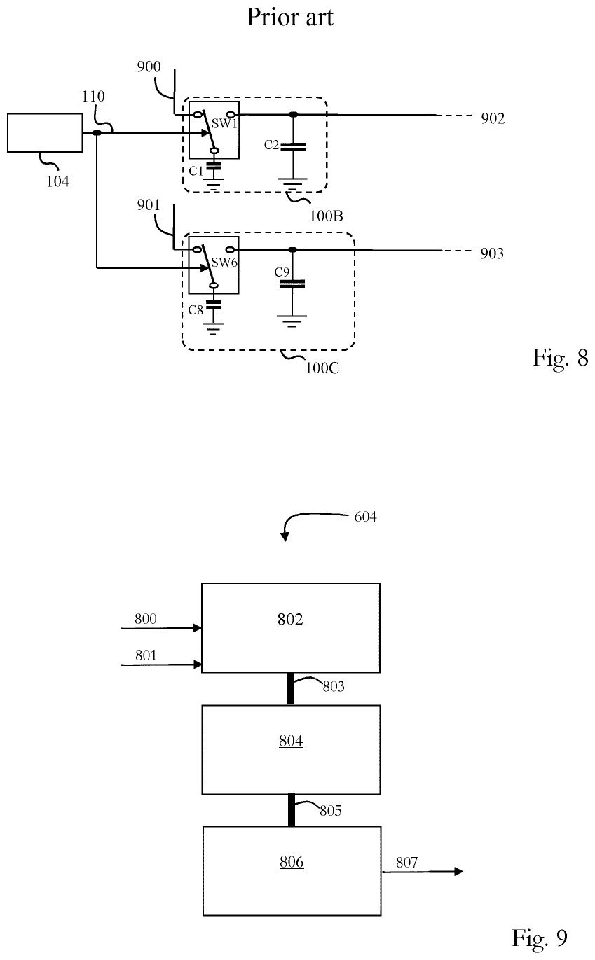

FIG. 8 repeats the basic circuit for a 3D acquisition pixel, as described in patent application WO2022043480. For example, a sine-signal is applied to F1 900, and a cosine signal to F2 901, and each time a trigger results from an incident photon on the SPAD circuit 104, this is taken up in the averaging signals on nodes Average1 902 and Average2 903.

Circuit 100B and 100C operate as average taking systems, based on the moving exponential averaging. It has been recognized that this pixel may also be used for measuring distances and constructing a 3D time-of-flight camera. Making a reconfigurable pixel, and hence camera that may be operated to do either (of both) HDR image sensing and 3D imaging, yields the opportunity to making a small system that may not require image registration with additional optics like optical beam splitters, or the like, thereby keeping costs low.

FIG. 9 shows the non-linear voltage signal generator 604, as already mentioned above which is configured to generate the non-linear voltage curve ttA 214 that drops in time as indicated in FIG. 5.

In the first 2 microseconds it drops 25%, whilst the last 25% drop of the signal is between 200 μs and 2 ms. The first block contains counter 802, that has a fine resolution, e.g., 16 bit. It gets reset to zero at the start of the frame, by the input frameStart 801. A high-speed clock is provided to the input clock 800 which runs the internal counter. The count value is brought out via a bus 803.

A combinatorial function 804 is applied to this input signal 803 choosing the values for the DAC 806, on bus 805. A 11 or a 10 bits resolution may suffice for bus 805 and for the connected DAC 806. The DAC uses this value and constructs the output signal on node ttA 807. This voltage is supplied to the image sensor array, possibly after additional buffering. The logic 804 can easily be defined by the (analog) voltage wave-from, like the ttA 214 waveform in FIG. 5. The non-linear voltage signal generator 604 can drive the ttA 113 voltage for a full image sensor or a part of it.

FIG. 10 depicts a method 1000 for operating an image sensor pixel according to the present disclosure.

At 1001, a pulse is generated by a SPAD circuit in response to an incident photon, as discussed herein.

At 1002, a charge pump integrates a number of photons, as discussed herein.

At 1003, a comparator generates an overflow signal when the number of incident photons exceeds a predetermined threshold (200 photons, in this embodiment), as discussed herein.

At 1004, a sample and hold switch registers a point of time at which the overflow signal is generated, as discussed herein.

It should be recognized that the embodiments describe methods with an exemplary ordering of method steps. The specific ordering of method steps is however given for illustrative purposes only and should not be construed as binding.

Please note that the division of the signal generator 604 into units 802 to 806 is only made for illustration purposes and that the present disclosure is not limited to any specific division of functions in specific units. For instance, the control signal generator 604 could be implemented by a respective programmed processor, field programmable gate array (FPGA) and the like.

The methods discussed herein can also be implemented as a computer program causing a computer and/or a processor, such as processor, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

The drawings are only schematic and should be construed as non-limiting. In the drawings, the size of some of the elements may be exaggerated and not drawn on scale for illustrative purposes. The dimensions and the relative dimensions may not necessarily correspond to actual reductions to practice of the disclosure. In the different figures, the same reference numbers refer to the same or analogous elements.

It is to be noticed that the term “coupled” should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

Note that the present technology can also be configured as described below.

(1) An image sensor pixel comprising:
a single photon avalanche diode configured to generate a pulse in response to detection of incident photons;
a charge pump configured to integrate a number of the incident photons;
a comparator configured to generate an overflow signal when the number of incident photons exceeds a predetermined threshold; and
a sample and hold switch configured to register a point of time at which the overflow signal is generated.

(2) The image sensor pixel of (1), wherein the registering is based on a monotonic signal.

(3) The image sensor pixel of (2), wherein the monotonic signal is a monotonically increasing or monotonically decreasing signal.

(4) The image sensor pixel of (2) or (3), wherein the monotonic signal is provided for high dynamic range light input reconstruction.

(5) The image sensor pixel of anyone of (2) to (4), wherein the monotonic signal is an analog signal.

(6) The image sensor pixel of anyone of (2) to (5), wherein the sample and hold switch is further configured to sample the monotonic signal for registering the point of time.

(7) The image sensor pixel of anyone of (2) to (6), wherein the monotonic signal corresponds to a non-linear curve.

(8) The image sensor pixel of anyone of (1) to (7), wherein the charge pump comprises a switching capacitor configured to integrate the number of the incident photons, wherein the integrated number of photons is determined based on an average voltage of the switching capacitor.

(9) The image sensor pixel circuitry of anyone of (2) to (8), wherein the monotonic signal changes according to a line in a graph having a logarithmic time scale over at least two orders of magnitude in time.

(10) The image sensor pixel of anyone of (1) to (9), further configured to, based on the number of photons, to lock a voltage value which is indicative of a light level.

(11) The image sensor pixel of anyone of (1) to (10), wherein the pixel is a time-of-flight pixel.

(12) An image sensor comprising a plurality of image sensor pixels, each pixel including:
a single photon avalanche diode configured to generate a pulse in response to detection of incident photons;
a charge pump configured to integrate a number of the incident photons;
a comparator configured to generate an overflow signal when the number of incident photons exceeds a predetermined threshold; and
a sample and hold switch configured to register a point of time at which the overflow signal is generated, wherein
the image sensor further comprises image sensor circuitry configured to only output a read-out signal for the pixels of the plurality of image sensor pixels which generated an overflow signal.

(13) A method for operating an image sensor pixel, the method comprising:
generating, by a single photon avalanche diode, a pulse in response to detection of incident photons;
integrating, by a charge pump, a number of the incident photons;
generating, by a comparator, an overflow signal when the number of incident photons exceeds a predetermined threshold; and
registering, by a sample and hold switch, a point of time at which the overflow signal is generated.

(14) The method of (13), wherein the registering is based on a monotonic signal.

(15) The method of (14), wherein the monotonic signal is a monotonically increasing or monotonically decreasing signal.

(16) The method of (14) or (15), wherein the monotonic signal is provided for high dynamic range light input reconstruction.

(17) The method of anyone of (14) to (16), wherein the monotonic signal is an analog signal.

(18) The method of anyone of (14) to (17), further comprising, by the sample and hold switch, sampling the monotonic signal for registering the point of time.

(19) The method of anyone of (14) to (18), wherein the monotonic signal corresponds to a non-linear curve.

(20) The image sensor pixel circuitry of anyone of (14) to (19), wherein the monotonic signal changes according to a line in a graph having a logarithmic time scale over at least two orders of magnitude in time.

(21) The method of anyone of (13) to (20), wherein the charge pump includes a switching capacitor, the method further comprising: integrating, by the switching capacitor, the number of incident photons, wherein the integrated number of photons is determined based on an average voltage of the switching capacitor.

(22) The method of anyone of (13) to (21), further configured to, based on the number of photons, to lock a voltage value which is indicative of a light level.

(23) A computer program comprising program code causing a computer to perform the method according to anyone of (13) to (22), when being carried out on a computer.

(24) A non-transitory computer-readable recording medium that stores therein a computer program product, which, when executed by a processor, causes the method according to anyone of (13) to (22) to be performed.

1. An image sensor pixel comprising:
a single photon avalanche diode configured to generate a pulse in response to detection of incident photons;
a charge pump configured to integrate a number of the incident photons;
a comparator configured to generate an overflow signal when the number of incident photons exceeds a predetermined threshold; and
a sample and hold switch configured to register a point of time at which the overflow signal is generated.

2. The image sensor pixel of claim 1, wherein the registering is based on a monotonic signal.

3. The image sensor pixel of claim 2, wherein the monotonic signal is a monotonically increasing or monotonically decreasing signal.

4. The image sensor pixel of claim 2, wherein the monotonic signal is provided for high dynamic range light input reconstruction.

5. The image sensor pixel of claim 2, wherein the monotonic signal is an analog signal.

6. The image sensor pixel of claim 2, wherein the sample and hold switch is further configured to sample the monotonic signal for registering the point of time.

7. The image sensor pixel of claim 2, wherein the monotonic signal corresponds to a non-linear curve.

8. The image sensor pixel of claim 1, wherein the charge pump comprises a switching capacitor configured to integrate the number of the incident photons, wherein the integrated number of photons is determined based on an average voltage of the switching capacitor.

9. The image sensor pixel of claim 1, further configured to, based on the number of photons, to lock a voltage value which is indicative of a light level.

10. The image sensor pixel of claim 1, wherein the pixel is a time-of-flight pixel.

11. An image sensor comprising a plurality of image sensor pixels, each pixel including:
a single photon avalanche diode configured to generate a pulse in response to detection of incident photons;
a charge pump configured to integrate a number of the incident photons;
a comparator configured to generate an overflow signal when the number of incident photons exceeds a predetermined threshold; and
a sample and hold switch configured to register a point of time at which the overflow signal is generated, wherein
the image sensor further comprises image sensor circuitry configured to only output a read-out signal for the pixels of the plurality of image sensor pixels which generated an overflow signal.

12. A method for operating an image sensor pixel, the method comprising:
generating, by a single photon avalanche diode, a pulse in response to detection of incident photons;
integrating, by a charge pump, a number of the incident photons;
generating, by a comparator, an overflow signal when the number of incident photons exceeds a predetermined threshold; and
registering, by a sample and hold switch, a point of time at which the overflow signal is generated.

13. The method of claim 12, wherein the registering is based on a monotonic signal.

14. The method of claim 13, wherein the monotonic signal is a monotonically increasing or monotonically decreasing signal.

15. The method of claim 13, wherein the monotonic signal is provided for high dynamic range light input reconstruction.

16. The method of claim 13, wherein the monotonic signal is an analog signal.

17. The method of claim 13, further comprising, by the sample and hold switch, sampling the monotonic signal for registering the point of time.

18. The method of claim 13, wherein the monotonic signal corresponds to a non-linear curve.

19. The method of claim 12, wherein the charge pump includes a switching capacitor, the method further comprising: integrating, by the switching capacitor, the number of incident photons, wherein the integrated number of photons is determined based on an average voltage of the switching capacitor.

20. The method of claim 12, further configured to, based on the number of photons, to lock a voltage value which is indicative of a light level.
